(19) United States
(12) Patent Application Publication
(10) Pub. No.: US 2007/0117578 A1
(43) Pub. Date: May 24, 2007

(54) Short message service system and method

(76) Inventors: Jong Choul Yim, Daejeon-city (KR); Young Il Choi, Daejeon-city (KR); Byung Sun Lee, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/438,200

(22) Filed: May 22, 2006

(30) Foreign Application Priority Data
Nov. 18, 2005 (KR) 10-2005-0110821

(51) Int. Cl. H04Q 7/20

(52) U.S. Cl. 455/466

(57) ABSTRACT

Provided is a short message service (SMS) system and method, in which a SMS user can directly specify a group (for example, Internet club) of an Internet community and a messenger as a SMS receiver and collectively transmit the same message to several persons belonging to the group. The short message service (SMS) system includes a service request determining unit which determines whether a SMS transmitter requests a short message transmitting service in a group unit, based on a text of the short message in which a specific group is designated as a receiver; a group extracting unit which receives the text from the service request determining unit and extracts the group designated by the transmitter; and a message transmitting unit which requests a server for acquiring information on the extracted group, receives list of terminal numbers of members of the extracted group, and collectively transmits the short message to the terminals of the members.

### CROSS-REFERENCE TO RELATED PATENT APPLICATION

This application claims the benefit of Korean Patent Application No. 10-2005-0110821, filed on Nov. 18, 2005, in the Korean Intellectual Property Office, the disclosure of which is incorporated herein in its entirety by reference.

### BACKGROUND OF THE INVENTION

1. Field of the Invention

The present invention relates to a short message service (SMS) system and method, and, more particularly, to a multi-address short message service system and method, in which a SMS user can directly designate a group of an Internet community and a messenger as a SMS receiver and collectively transmit the same message to several persons belonging to the group.

2. Description of the Related Art

In a short message service using a mobile terminal used popularly, only one receiver can be designated in a receiver field of a transmission message frame. To this end, when a transmitter wants to transmit a short message to a specific group, the short message must be repeatedly transmitted to members of the group in an individual-to-individual service manner.

Accordingly, a function of grouping several receivers and transmitting a short message to the group was developed. This function seems to allow a transmitter to transmit the short message to the group by one operation. However, actually, in this function, a transmitting terminal repeatedly transmits the short message to the receivers of the group, which is similar to the individual-to-individual service manner.

A SMS system which transmits a short message to a group over the Internet is widely being used, but is restricted in time or space since the Internet must be first accessed. In order to address the shortcoming of the SMS system using the Internet, a system for transmitting a short message to a group using an abbreviated code for specifying the group was developed. However, this system cannot use a group on the existing Internet site, that is, a separate group is newly created, and a transmitter must memorize the abbreviated code.

### SUMMARY OF THE INVENTION

The present invention provides a short message service (SMS) system and method, in which a user can directly designate a group of an Internet community and a messenger as a SMS receiver that is, directly input a name of a group, and collectively transmit the same message to several persons belonging to the group.

According to an aspect of the present invention, there is provided a short message service (SMS) system including a short message service (SMS) system comprising: a service request determining unit which determines whether a SMS transmitter requests a short message transmitting service in a group unit, based on a text of the short message in which a specific group is designated as a receiver; a group extracting unit which receives the text from the service request determining unit and extracts the group designated by the transmitter; and a message transmitting unit which requests a server for acquiring information on the extracted group, receives list of terminal numbers of members of the extracted group, and collectively transmits the short message to the terminals of the members.

According to another aspect of the present invention, there is provided a short message service (SMS) method including (a) determining whether a SMS transmitter requests a group transmission service of a short message based on a text of the short message in which a specific group is specified as a receiver in the text; (b) extracting the group designated by the transmitter from the text; (c) requesting a server for acquiring information on the extracted group to transmit terminal numbers of members of the extracted group and receiving the terminal numbers; and (d) collectively transmitting the short message to the terminals of the members.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of a multi-address short message service (SMS) system according to an embodiment of the present invention;

FIG. 2 illustrates an example of a format of a short message text according to an embodiment of the present invention;

FIG. 3 illustrates an example of a short message according to an embodiment of the present invention;

FIG. 4 illustrates an example of grouping members using a group management server according to an embodiment of the present invention;

FIG. 5 illustrates an example of a group information table designated in the group management server according to an embodiment of the present invention;

FIG. 6 illustrates examples of lists of terminal numbers acquired when a multi-address messaging application server requests a group to a group management server according to an embodiment of the present invention;

FIG. 7A illustrates a configuration of a SMS system according to an embodiment of the present invention; and

FIG. 7B is a flowchart illustrating a SMS method according to an embodiment of the present invention.

### DETAILED DESCRIPTION OF THE INVENTION

Hereinafter, the present invention will be described in detail by explaining exemplary embodiments of the invention with reference to the attached drawings. Like reference numerals in the drawings denote like elements.

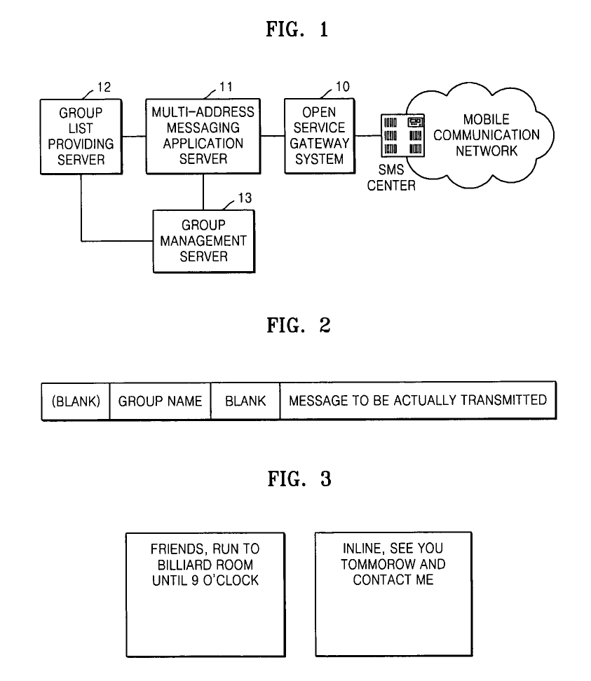

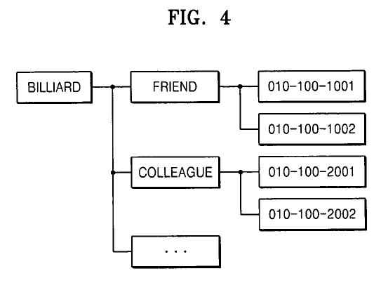

FIG. 1 illustrates a configuration of a multi-address short message service (SMS) system according to an embodiment of the present invention.

The multi-address short message service system using a group name according to the present embodiment includes a mobile terminal, a mobile communication network for transmitting/receiving a short message, an open service gateway system 10, a multi-address messaging application server 11, a group list providing server 12, and a group management server 13. The terminal and the mobile communication network including a SMS center are known to those of ordinary skill in the art and thus their description will be omitted.

The open service gateway system 10 directly communicates with an infrastructure or a communication network of a communication provider and communicates with the multi-address messaging application server 11 through Parlay application programming interface (API) or Parlay X API which are an open standard technology. The multi-address messaging application server 11 is an instance of open service application server. The open service gateway system 10 according to the present embodiment provides the multi-address messaging application server 11 with an API which can transmit/receive a short message.

The multi-address messaging application server 11 is necessarily used for transmitting/receiving the short message through the mobile communication network using a SMS-related API provided by the open service gateway system 10.

The multi-address messaging application server 11 receives a short message frame having a predetermined format from the open service gateway system 10 and parses the short message text. When a specific group is designated as a receiver in the short message text, the multi-address messaging application server 11 requests the group management server 13 or the group list providing server 12 to search for the specified group and acquires a list of terminal numbers of members belonging to the group. When the list of terminal numbers of the members belonging to the group is acquired, the short message is transmitted to the terminals connected to the mobile communication network through the open service gateway system 10. Before transmitting the short message, it must be determined whether the same terminal number exists in the list of terminal numbers. When the same terminal number exists in the list of terminal numbers, the short message is allowed to be transmitted to a terminal having the same terminal number once.

When the list of terminal numbers cannot be acquired, the multi-address messaging application server 11 receives an error message from the group management server 13 or the group list providing server 12 and transmits the transmitter with a message that the group does not exist. Even existing Internet community site or a group management server for messenger system can be a instance of the multi-address messaging application server by directly interfacing with the open service gateway system and by implementing the group extracting unit and transmitting unit.

When a SMS user transmits a multi-address short message, an example of a format of a message text is illustrated in FIG. 2.

A specific service code must be specified in a receiver field of the message frame and a group name is specified in the short message text, as illustrated in FIG. 2, while the receiver's terminal number is specified in a receiver field of the message frame normal one-to-one short messaging system. The meaning of the specific service code will be apparent in the following description. A zero or more white space characters are specified in an opening part of the message frame and a group composed of normal characters such as English, Korean, special characters, and numeric characters is subsequently specified. Although described below, a nickname of the group may be designated in addition to the group name to improve convenience in the usage of a messaging service. Subsequent to the group name, at least one white space character and a short message to be actually transmitted are sequentially designated. Here, the at least one white space character must be necessarily included, which allows the multi-address messaging application server 11 to simply parse the short message.

FIG. 3 illustrates an example of a multi-address short message generated by a format illustrated in FIG. 2.

In FIG. 3, “friend” and “inline”, which are groups managed by the existing servers, are used as the group name. The group list providing server 12, which exists already, manages the group such as the existing messenger or club on the Internet. The group list providing server 12 provides group information (terminal numbers, etc.) to the group management server 13 or the multi-address messaging application server 11 in an online or offline.

When the group information is provided in an online, the group information is provided in a form of searching the group list and returning the searched result, such as a common object request broker architecture (CORBA) form, a remote procedure call form using a technology such as a web service, a protocol data unit (PDU) exchange form, or a direct database query/answer form. At this time, when searching the group list, the group name is included as a keyword and, when a group corresponding to the keyword exists, the searched result including a list of terminal numbers is returned. When the group corresponding to the keyword does not exist, an error message is returned.

The group management server 13 manages existing groups on the Internet messenger or community web site designated by the group list providing server 12 and newly defined groups in an integrated manner. In particular, the group management server 13 is useful when a transmitter makes a new group (newly defines a group) and transmits a message to the new group and may be optionally included in the present invention.

In other words, although the group management server 13 does not exist, the multi-address messaging application server 11 can provide a SMS service to the existing group in cooperation with the group list providing server 12. However, the group management server 13 is preferably included in consideration of variety and expandability of the service according to the present invention.

The group management server 13 performs various management/edit functions related to the group, such as a function of making a new group different from the existing group, a function of collecting and managing several pieces of group information on the Internet, a function of grouping sub groups (“friend”, “colleague”, etc.) to form an upper-layer group (for example, billiard), a function of specifying a nickname of a group. In order to perform these functions, the group management server 13 allows the user to set and manage these functions.

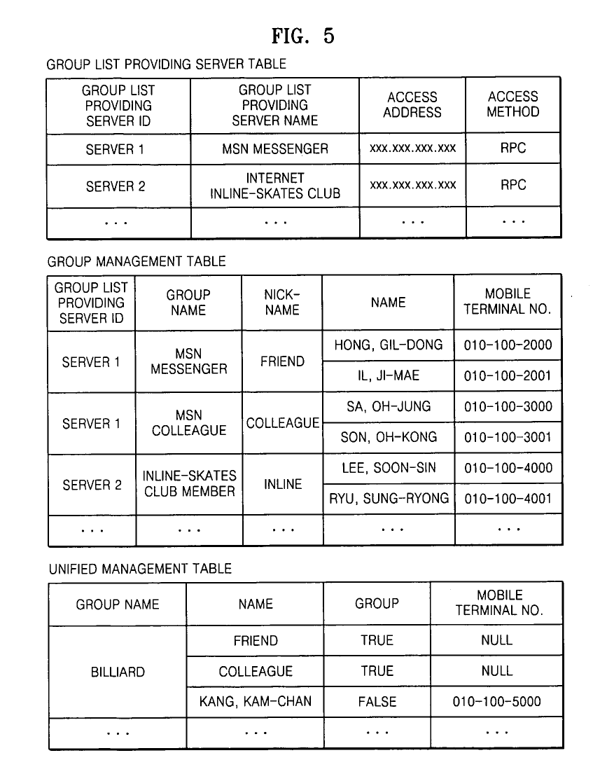

FIG. 5 illustrates an example of a group information table managed by the group management server.

The group information table managed by the group management server 13 includes a group list providing server table for retrieving/storing server information of a group acquired from the group list providing server 12, a group management table for retrieving/storing detailed information on the group acquired from the group list providing server 12, and a unified management table for collectively managing the group acquired from the group list providing server 12 and newly defined group.

The group list providing server table includes a group list providing server ID, a group list providing server name, an access address for requesting the group information, and an access method. The group management table is formed based on the group list providing server table, is used for retrieving/storing more detailed information on the group acquired from the group list providing server 12, and includes more detailed information than that of the group list providing server table, such as a group list providing server ID, a group name registered in the group list providing server, a nickname of the group name, and information on members for comprising the group.

The unified management table collectively manages the group acquired from the group list providing server 12 and newly defined group and includes a group name for identifying a specific group, a name representing the members of the group, and a mobile terminal number. Since a group may include sub groups, the unified management table includes information as to whether a group member is included in another group.

The SMS user may use all group names and nicknames which are designated in group management table, group names which are designated in unified management table as a receiver when transmitting the short message. When the list is searched using the group name, the list is searched in the order of th group name which is designated in the unified management table, the nickname which is designated in the group management table, and the group name which is designated in the group management table. The searching order may vary depending on a service provider's intention. When a specified group name itself includes the sub group, the list for configuring the sub group must be searched using the sub group name.

By configuring three tables, the transmitter can variously designate the name of the same group when designating a reception group. This is because the group designated as the reception group is searched in the individual information unit of each table.

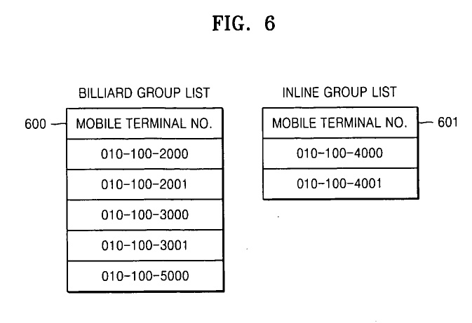

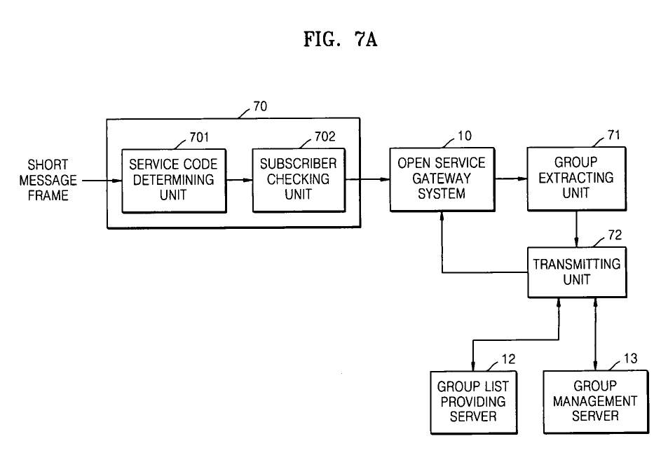

FIG. 6 illustrates examples of lists of terminal numbers obtained when a multi-address messaging application server 11 requests group names “billiards” (600) and “inline” (601) to the group management server 13 or the group list providing server 12, based on the table illustrated in FIG. 5.

When receiving a short message of which the frame has a predetermined service code in receiver field (for example, **1234) from the user, the SMS center notifies the open service gateway system 10 that the short message having the predetermined service code is received. Here, the predetermined service code is used as a service access code representing that a user subscribes to the multi-address short message service, and is previously determined by an online/offline agreement among a mobile communication network provider, the open service gateway system 10, and the multi-address messaging application server 11.

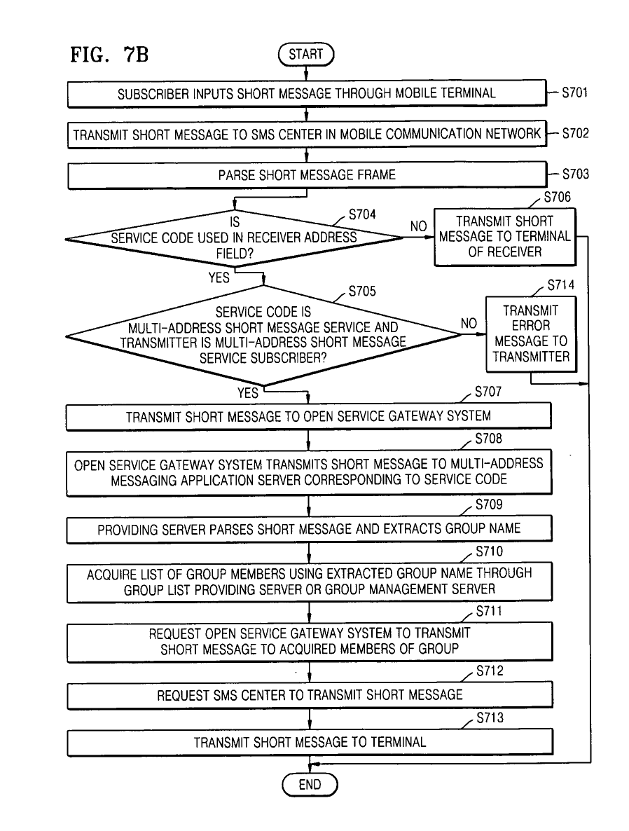

FIG. 7A illustrates a configuration of a SMS system according to an embodiment of the present invention, and FIG. 7B is a flowchart illustrating a SMS method according to an embodiment of the present invention.

In order to embody the present embodiment, a mobile communication subscriber must subscribe to a service provided by the mobile communication network provider and the multi-address messaging service provider (multi-address messaging application server 11), and the multi-address messaging service provider must have a privilege accessible to group information of existing servers or sites through an agreement with Internet service providers such as Internet community web sites or the messenger systems. Furthermore, the multi-address messaging service provider can manage the group management server 13 such that the mobile communication subscriber can directly manage a group over the Internet.

A multi-address messaging service subscriber inputs a short message through a mobile terminal (S701) and transmits the short message to a receiver, the short message is transmitted to the SMS center in the mobile communication network (S702). At this time, a specific service code must be given in a receiver address field when inputting the short message, and the group name must be included in the short message text.

A service request determining unit 70, which is provided in the SMS center, analyses a short message frame received from a transmitter (S703) and determines whether the transmitter requests the multi-address short message service. In other words, a service code determining unit 701 determines whether a specific service code is used in the receiver address field (S704).

If a general terminal address is used, that is, the specific service code is not used, the short message is transmitted to a terminal having the general terminal address (S706), and, otherwise, the service code determining unit 701 determines whether the specific service code represents a multi-address short message service, and a subscriber checking unit 702 checks whether the transmitter is the multi-address short message service subscriber (S705). If the transmitter is not the multi-address short message service subscriber, an error message is transmitted to the terminal of the transmitter (S714), and, if the transmitter is the multi-address short message service subscriber, the short message is transmitted to the open service gateway system 10 (S707).

The open service gateway system 10 checks the service code and transmits the short message to the multi-address messaging application server 11 for processing the service code (S708). A group extracting unit 71 of the multi-address messaging application server 11 parses the received short message frame illustrated in FIG. 2 and extracts a reception group (S709). If the reception group does not exist, an error message is transmitted through the open service gateway system 10, although not illustrated in FIG. 7A.

When the group extracting unit 71 extracts the reception group, a multi-address short message transmitting unit 72 requests and acquires a list of members of the extracted group from the group list providing server 12 or the group management server 13 (S710) and requests the open service gateway system 10 to transmit the short message to the member of the group (S711). The open service gateway system 10 requests the SMS center to transmit the short message (S712) and the SMS center transmits the short message to the terminal (S713). As the multi-address messaging application server executes S711 for each member of the group, S711, S712 and S713 are repeated until the short message is delivered to all members of the group.

As mentioned above, according to the present invention, when a short message is transmitted to a group composed of friends, colleagues, or club members, the groups from external system such as existing internet community and/or messenger system can be used. Furthermore, since a reception group is specified by a memorable name when writing a short message, it is possible to easily transmit the short message. Accordingly, according to the present invention, it is possible to address a restriction in time and space, unlike the conventional method of accessing the Internet and transmitting a short message to a group. Moreover the group on the existing Internet itself can be used.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily constructed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A short message service (SMS) system comprising:
a service request determining unit which determines whether a SMS transmitter requests a short message transmitting service in a group unit, based on a text of the short message in which a specific group is designated as a receiver;
a group extracting unit which receives the text from the service request determining unit and extracts the group designated by the transmitter; and
a message transmitting unit which requests a server for acquiring information on the extracted group, receives list of terminal numbers of members of the extracted group, and collectively transmits the short message to the terminals of the members.

2. The short message service system of claim 1, wherein the service request determining unit comprises:
a service code determining unit which determines whether a code of a receiver address field of the frame corresponds to the service; and
a subscriber checking unit which checks whether the transmitter is a subscriber of the service.

3. The short message service system of claim 1, wherein the server comprises:
a group list providing server which stores/manages information on existing groups; and
a group management server which stores/manages information on newly defined groups by the transmitter.

4. The short message service system of claim 3, wherein the group management server also manages the information on the existing groups in cooperation with the group list providing server.

5. The short message service system of claim 4, wherein the group management server classifies/stores information on every group in an individual information unit, and the transmitter can designate the same receiver using various names in the individual information unit.

6. A short message service (SMS) method comprising:
(a) determining whether a SMS transmitter requests a group transmission service of a short message based on a text of the short message in which a specific group is specified as a receiver in the text;
(b) extracting the group designated by the transmitter from the text;
(c) requesting a server for providing/managing information on the extracted group to transmit list of terminal numbers of members of the extracted group and receiving the terminal numbers; and
(d) collectively transmitting the short message to the terminals of the members.

7. The short message service method of claim 6, wherein the server comprises:
a group list providing server which stores/manages information on existing groups; and
a group management server which stores/manages information on newly defined groups by the transmitter.

8. The short message service method of claim 7, wherein the group management server also manages the information on the existing groups in cooperation with the group list providing server.

9. The short message service method of claim 8, wherein the group management server classifies/stores information on every group in an individual information unit, and the transmitter can designate the same receiver using various names in the individual information unit.
